(19) United States
(12) Patent Application Publication
(10) Pub. No.: US 2026/0249942 A1
(43) Pub. Date: Aug. 27, 2026

(54) Vehicle

(71) Applicant: Bayerische Motoren Werke Aktiengesellschaft, Muenchen (DE)

(72) Inventor: Bernhard NEUHEUSER, Unterschleissheim (DE)

(21) Appl. No.: 19/489,740

(22) PCT Filed: Jun. 20, 2024
(86) PCT No.: PCT/EP2024/067184

§ 371 Date: Dec. 3, 2025

(30) Foreign Application Priority Data
Jul. 6, 2023 (DE) 10 2023 117 793.1

(51) Int. Cl. B62J 43/28; B60L 53/16; B62J 43/16

(52) U.S. Cl. CPC B62J 43/28; B60L 53/16; B62J 43/16; B60L 2200/12

(57) ABSTRACT

A vehicle, in particular a motor vehicle, such as a motorcycle, includes at least one electric load and an internal power supply. The vehicle is designed such that the at least one electric load can be supplied with energy via the internal power supply, and the vehicle has an electric connection which is operatively connected to the at least one electric load such that the electric load can be supplied with energy independently of the internal power supply.

### BACKGROUND AND SUMMARY

The present disclosure relates to a vehicle such as, for example, a motor vehicle.

Vehicles, in particular motor vehicles, are increasingly electrified. This relates not only to the drive but also to additional functions such as interlocks, locks or the like, which often can only be actuated electronically. Problems result when the power supply of the respective vehicle fails, the additional functions or electric loads can therefore no longer be supplied with power.

It is an object of the present disclosure to specify a vehicle which can provide further functions even without an internal power supply.

This object is achieved by a vehicle according to the present disclosure. Further advantages and features can also be gathered from the description and the appended FIGURE.

According to the present disclosure, a vehicle, in particular a motor vehicle such as a motorcycle, comprises at least one electric load and an internal power supply, wherein the vehicle is designed such that the at least one electric load can be supplied with power via the internal power supply, in other words can be energized, and wherein the vehicle has an electric connection which is operatively connected to the at least one electric load in such a way that the electric load can be supplied with power independently of the internal power supply, in other words can be energized. As a result, a possible way of energizing the electric load is advantageously devised, even if the internal power supply is not present or has failed or is just not available. The at least one electric load is, for example, a device which is operated electrically in some way such as, for example, electric sensors, a (servo) motor, a computing unit such as a control device, etc.

The vehicle is in particular a motor vehicle such as, for example, a motorcycle. In the present case, motorcycles are understood in particular to be tilting vehicles, this including both single-track and multi-track vehicles such as, for example, also leaning multi-wheel vehicles (LMW). Multi-track motorcycles can be quad bikes, for example. Motor vehicles can also be commercial vehicles or passenger vehicles. In addition, vehicles can however also be other vehicles which are not motor vehicles, such as bicycles with or without an auxiliary electric motor. Vehicles of the type under discussion are preferably cross-country vehicles, but do not have to be restricted thereto. However, without restricting the generality, the following explanations primarily relate to a motor vehicle, in particular a motorcycle such as a motorbike or scooter.

The electric load can be a steering wheel lock which preferably can also be unlocked or, more generally, “actuated” even without an internal power supply.

According to a preferred embodiment, the at least one electric load is the electrically operated closing mechanism of a cover which is designed to lock the cover, which can be moved from a closed position to an open position, in the closed position. Advantageously, the electric connection therefore permits blocking of the closing mechanism and therefore the opening of the cover even if the internal power supply of the vehicle does not operate, be it because it is not present or does not function, etc. Advantageously, therefore, it is possible to dispense with mechanical emergency unlocking or the like. Emergency unlocking in the form of a mechanical solution would entail the disadvantage that unauthorized persons would also be enabled to open the cover.

According to various embodiments, the vehicle comprises an arrangement space, wherein the cover is designed to close the arrangement space when in the closed position. The aforementioned arrangement space is, for example, a stowage space which is used to accommodate objects. According to various embodiments, for example, a traction battery of the vehicle is accommodated in the arrangement space. According to various embodiments, the traction battery comprises multiple energy storage modules, which are accommodated in the arrangement space. Here, mechanical emergency unlocking which could be opened by anyone would be particularly problematic.

According to various embodiments, a vehicle electrical system can be activated by the electric connection. Accordingly, all electric loads which are operatively connected to the vehicle electrical system can be activated via the electric connection. Alternatively, the electric connection is also connected only to one or at least one selected electric load.

Expediently, the ability to activate is permitted only via a further identification, such as a vehicle key or a mobile terminal (such as a smartphone), which is recognized by the vehicle. Expediently, the vehicle is designed such that the electric connection cannot be actuated or activated by anyone but only by selected individuals such as, for example, the driver, who is recognized by the vehicle in a suitable way.

According to preferred embodiments, the aforementioned cover is a seating device of the vehicle. In the case of a motorcycle such as a motorbike or a scooter, the seating device is a saddle, for example. According to preferred embodiments, this closes an arrangement space/stowage space located underneath, in which one or more traction batteries and/or also other objects can be accommodated.

Preferably, the electric connection is accessible from outside. More preferably, the electric connection is in particular accessible without a tool. Preferably, the electric connection is visible from outside. In the case in which the electric connection is housed or the like in any way, this housing can preferably be opened without a tool.

The electric connection can be, for example, a 12-volt (V) charging point, via which the at least one electric load can be activated or energized, and/or the vehicle electrical system, in particular the 12 V vehicle electrical system, can be activated, in particular independently of the internal power supply of the vehicle. The electric connection can comprise one or two terminals, contact elements or pins. The aforementioned vehicle electrical system voltage of 12 V is to be understood merely as an example. The voltage can also assume lower and, above all, higher values such as, preferably, 24 V or 48 V.

Preferably, the internal power supply has a first power supply unit and a second power supply unit, and the vehicle has an electric drive motor, which can be supplied with power via the second power supply unit, and the at least one electric load is designed to be supplied with power in particular via the first power supply unit. In addition, a power supply via the second power supply unit can also be possible. According to preferred embodiments, the vehicle is therefore in particular an electrically operated motor vehicle such as an electrically operated scooter or an electrically operated motorbike. The second power supply unit is the traction battery already mentioned. As likewise already mentioned, this can have one or more energy storage modules, which are preferably designed to be interchangeable in order, for example, to charge them externally.

According to preferred embodiments, the first power supply unit is a power supply unit permanently installed in the vehicle, such as a 12 V battery. The expression “permanently installed” is to be understood in particular to mean that this power supply unit or its fastening or arrangement are not configured in such a way that particularly fast or tool-free installation is to be possible. As already mentioned, the vehicle expediently has a vehicle electrical system, wherein the power supply units and the electric drive motor and the electric loads or the at least one electric load are connected to this vehicle electrical system. Expediently, it is possible to activate the vehicle electrical system via the electric connection, wherein operation of the at least one electric load such as, for example, the closing mechanism of the cover, is made possible irrespective of the state of charge or presence of the first power supply unit or the 12 V battery and/or also the presence or the state of the second power supply unit such as, for example, the traction battery.

Expediently, the vehicle comprises an external power supply unit which is designed to make contact with the electric connection and for the power supply of the at least one electric load such as, for example, the closing mechanism.

The external power supply unit can be a power supply, a charging device or an immobile power supply unit such as, for example, a power bank, a battery, a rechargeable battery, etc. All the aforementioned devices or equipment can be connected easily and without complication because of the simple accessibility of the electric connection. The external power supply unit can be an item of additional equipment which is separate from the vehicle or can be transported along on the vehicle.

As a result, the functionality or flexibility of the underlying vehicle is considerably increased. According to a preferred embodiment, the motor vehicle is equipped with an electric drive and with traction batteries, which can easily be removed by the customer or dealer or in the workshop. The access to the batteries is made possible by the removal of the saddle, for example. It is secured by an electric interlock. One problem arises, for example, when the 12 V battery of the vehicle electrical system that is to be unlocked when the ignition is switched on is defective or is deeply discharged, for example over the winter, or has been removed and unlocking is no longer possible. Activation of the vehicle electrical system by the traction batteries is usually not possible since these batteries have possibly been removed from the vehicle over the winter. Charging the 12 V vehicle electrical system battery via the charging device of the traction battery is not possible, since this is enabled only when the 12 V vehicle electrical system is active. Mechanical unlocking of the saddle would entail the disadvantage that the very expensive traction batteries could be stolen. Advantageously, therefore, for example the electric connection permits safe emergency unlocking independently of the internal power supply of the vehicle.

Further advantages and features can be gathered from the following description of various exemplary embodiments of a vehicle according to the present disclosure, with reference to the appended FIGURE.

### BRIEF DESCRIPTION OF THE DRAWING

FIG. 1 shows a schematic view of various embodiments of a vehicle according to the present disclosure.

### DETAILED DESCRIPTION OF THE DRAWING

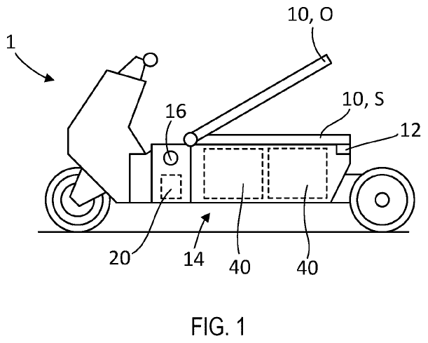

FIG. 1 shows, schematically, a vehicle 1, this being an electrically operated scooter, for example. This has at least an electric drive motor such as, for example, an electric motor, this not being illustrated here. It is possible to see an arrangement space 14, in which in the present case, illustrated dashed, two second power supply units 40 are arranged. The arrangement space 14 can be closed via a cover 10. In the present case, the cover 10 is designed as a seating device, in particular as a saddle. This can be closed via a closing mechanism 12. The cover 10 or the saddle is shown in an open position O and in a closed position S. In the closed state, the closing mechanism 12 can prevent opening. The closing mechanism 12 is an electric load which has to be supplied with power in order to function. The electric load 12 is, for example, connected to a first power supply unit 20 via a vehicle electrical system, not outlined here. According to one embodiment, this is a 12 V battery, in particular a power supply unit which is permanently installed in the vehicle, for example cannot be removed without a tool. Advantageously, the vehicle 1 has an electric connection 16, via which the at least one electric load 12 can be supplied with power directly or indirectly, for example via the vehicle electrical system. Thus, actuation of the closing mechanism 12 is also possible when the internal power supply, in the present case comprising the first power supply unit 20 and the second power supply unit 40, is not available. The electric connection 16 comprises, for example, a positive terminal and optionally also a negative terminal, which permits the arrangement or contact with an external electric power supply, such as a charging device, a mains power unit, a battery, a rechargeable battery, a power bank, etc.

### LIST OF REFERENCE SIGNS

1 Vehicle, motor vehicle, motorcycle
10 Cover, seating device, saddle
12 Electric load, closing mechanism
14 Arrangement space
16 Electric connection
20 First power supply unit
40 Second power supply unit
O Open position
S Closed position

1-10. (canceled)

11. A vehicle comprising:
at least one electric load;
an internal power supply, wherein the vehicle is configured such that the at least one electric load can be supplied with power via the internal power supply; and
an electric connection that is operatively connected to the at least one electric load such that the electric load can be supplied with power independently of the internal power supply.

12. The vehicle according to claim 11,
wherein the vehicle is a motorcycle.

13. The vehicle according to claim 11,
wherein the at least one electric load is an electrically operating closing mechanism of a cover that is configured to lock the cover in a closed position, which cover is configured to be moved from the closed position to an open position.

14. The vehicle according to claim 13, comprising:
an arrangement space,
wherein the cover closes the arrangement space when in the closed position.

15. The vehicle according to claim 13,
wherein the cover is a seating device of the vehicle.

16. The vehicle according to claim 11,
wherein the electric connection is accessible from outside.

17. The vehicle according to claim 11,
wherein the electric connection is accessible without a tool.

18. The vehicle according to claim 11,
wherein the internal power supply comprises a first power supply unit and a second power supply unit,
wherein the vehicle comprises an electric drive motor configured to be supplied with power via the second power supply unit, and
wherein the at least one electric load is configured to be supplied with power via the first power supply unit.

19. The vehicle according to claim 18,
wherein the first power supply unit is a power supply unit permanently installed in the vehicle.

20. The vehicle according to claim 11, comprising:
an external power supply unit configured to make contact with the electric connection to supply power to the at least one electric load.

21. The vehicle according to claim 20,
wherein the external power supply unit is a power supply, a charging device, or a mobile power supply unit.
